(19) United States
(12) Patent Application Publication
(10) Pub. No.: US 2017/0158173 A1
(43) Pub. Date: Jun. 8, 2017

(54) DRIVING DEVICE

(71) Applicant: Murata Manufacturing Co., Ltd., Nagaokakyo-shi (JP)

(72) Inventor: Kenichi Kotani, Nagaokakyo-shi (JP)

(21) Appl. No.: 15/440,636

(22) Filed: Feb. 23, 2017

Related U.S. Application Data
(63) Continuation of application No. PCT/JP2015/064679, filed on May 22, 2015.

(30) Foreign Application Priority Data
Sep. 2, 2014 (JP) 2014-178343

(51) Int. Cl. B60S 1/18; B60S 1/56; F03G 7/06

(52) U.S. Cl. CPC B60S 1/18; F03G 7/065; B60S 1/56

(57) ABSTRACT

A driving device is provided that can suppress power consumption, and is excellent in response characteristics, and also capable of appropriately adjusting a revolving angle of a target member. According to an exemplary design, the device includes a rotational shaft supported by a housing and is capable of revolving in each of a positive and counter rotation direction about a Z-axis. Shape memory alloys formed in a wire-like shape apply an external force acting in the positive rotation direction to the rotational shaft by heat shrinkage. A bias spring applies an external force acting in the counter rotation direction to the rotational shaft. Moreover, a wiper is displaced following the rotation of the rotational shaft. A power supply system including power supply terminals, a relay member, relay terminals, and lead wires separately supplies power to three or more mutually different positions of the shape memory alloys.

### CROSS REFERENCE TO RELATED APPLICATIONS

The present application is a continuation of PCT/JP2015/064679 filed May 22, 2015, which claims priority to Japanese Patent Application No. 2014-178343, filed Sep. 2, 2014, the entire contents of each of which are incorporated herein by reference.

### TECHNICAL FIELD

The present disclosure relates to driving devices, and particularly relates to a driving device that is applied to a foreign object removing apparatus that removes foreign objects such as raindrops, dust, and the like.

### BACKGROUND

An example of a driving device is disclosed in Patent Document 1. According to this conventional design, a shape memory alloy provided in a drive unit performs self-heating due to a current being supplied thereto, and shrinks at a temperature higher than the transformation temperature. The shape memory alloy is formed in a coil shape so as to widen its operation range in accordance with a change in temperature. One end of the shape memory alloy is fixed with a hook, while the other end thereof is connected to a wire. The direction of the wire is changed by a pulley, and movement of the wire, whose direction has been changed, is propagated to a blade through a converter. Water drops on a mirror surface are removed by the blade revolution.

Patent Document 1: Japanese Unexamined Patent Application Publication No. 62-64649.

However, because a force in a shrinkage direction of the shape memory alloy formed in a coil shape is small, the shape memory alloy needs to be thick so as to give the blade a revolving force that exceeds a dynamic friction between the blade and the mirror. As a result, the power consumption for current supply to the shape memory alloy becomes unacceptably unfavorably large for the conventional design.

In addition, because heat capacitance of the shape memory alloy is large in the convention designs, it takes a long time for the temperature of the shape memory alloy to come down to a temperature equal to or lower than the transformation temperature from when the supply of the current is stopped (a cooldown time of the shape memory alloy is too long). In other words, the conventional designs have a problem in that response characteristics of the driving device are unfavorable so that an interval of repetitive operations becomes unacceptably long.

Further, it is difficult for the conventional designs to precisely control the amount of shrinkage of the shape memory alloy when the temperature of the shape memory alloy exceeds the transformation temperature. This raises a problem that it is difficult to appropriately adjust a revolving angle of the blade.

### SUMMARY OF THE INVENTION

In view of the conventional designs, the driving device disclosed there is provided to suppress power consumption, excellent in response characteristics, and also capable of appropriately adjusting a revolving angle of a target member.

A driving device according to the present disclosure includes a revolving member that is supported by a housing and is capable of revolving in each of a first direction and a second counter direction around a reference axis. Moreover, the device has a shape memory alloy formed in a wire-like shape that is configured to apply an external force acting in the first direction to the revolving member by heat shrinkage; an elastic body configured to apply an external force acting in the second direction to the revolving member; a target member that is displaced following the revolution of the revolving member; and a power supply system including power supply terminals in three or more positions of the shape memory alloy and configured to separately supply power so as to give a potential difference between the power supply terminals adjacent to each other.

It is preferable that the above three or more positions include a specific power supply position for supplying a current to part of the shape memory alloy, and that the power supply system include a specific power supply terminal for supplying power to the specific power supply position and a support member which is movably provided in the housing and supports the specific power supply terminal.

In a certain aspect, the shape memory alloy is so supported by the support member as to extend in a zigzag pattern.

In another aspect, the number of the specific power supply positions is no less than two, and the shape memory alloy is divided into two or more partial shape memory alloys, to each of which the specific power supply position is assigned.

Further, it is preferable for the above two or more specific power supply positions to be assigned so that the two or more partial shape memory alloys at least partially overlap with each other when viewed in a specific direction.

It is preferable for the target member to include a wiper configured to revolve so as to remove raindrops.

It is preferable that the revolving member include a tapered first end surface which is formed at one end in the reference axis direction, and that the target member include a tapered second end surface which makes contact with the first end surface.

Forming a shape memory alloy in a wire-like shape makes it possible to suppress power consumption for current supply and improve response characteristics of the shape memory alloy with respect to the current supply. In addition, by supplying power separately to three or more positions of the shape memory alloy, the shape memory alloy shrinks in an amount in accordance with the power supply mode. This makes it possible to appropriately change a revolving angle of the revolving member.

The above-mentioned object, other objects, features, and advantages of the present disclosure will be further clarified through the following detailed descriptions of embodiments with reference to the drawings.

### BRIEF DESCRIPTION OF DRAWINGS

FIG. 1(A) is a front view of the raindrop removing device according to a first embodiment; FIG. 1(B) is a side view of the raindrop removing device of the first embodiment; and FIG. 1(C) is another front view where a wiper provided in the raindrop removing device of the first embodiment is revolved.

FIG. 2 is an exploded perspective view illustrating an example of a state where the raindrop removing device of the first embodiment is viewed in an oblique direction.

FIG. 3 is an exploded perspective view illustrating a state where the wiper provided in the raindrop removing device of the first embodiment is revolved.

FIG. 4 is an exploded perspective view illustrating an example of a state where a raindrop removing device of a second embodiment is viewed in an oblique direction.

FIG. 5 is an exploded perspective view illustrating an example of a state where a raindrop removing device of a third embodiment is viewed in an oblique direction.

FIG. 6 is an exploded perspective view illustrating an example of a state where a raindrop removing device of a fourth embodiment is viewed in an oblique direction.

FIG. 7 is an exploded perspective view illustrating an example of a state where a raindrop removing device of a fifth embodiment is viewed in an oblique direction.

FIG. 8 is an exploded perspective view illustrating an example of a state where a raindrop removing device of a sixth embodiment is viewed in an oblique direction.

FIG. 9 is an exploded perspective view illustrating an example of a state where a head driving device of a seventh embodiment is viewed in an oblique direction.

FIG. 10 is an exploded perspective view illustrating a state where a head provided in the head driving device of the seventh embodiment is displaced.

### DETAILED DESCRIPTION OF EMBODIMENTS

### First Embodiment

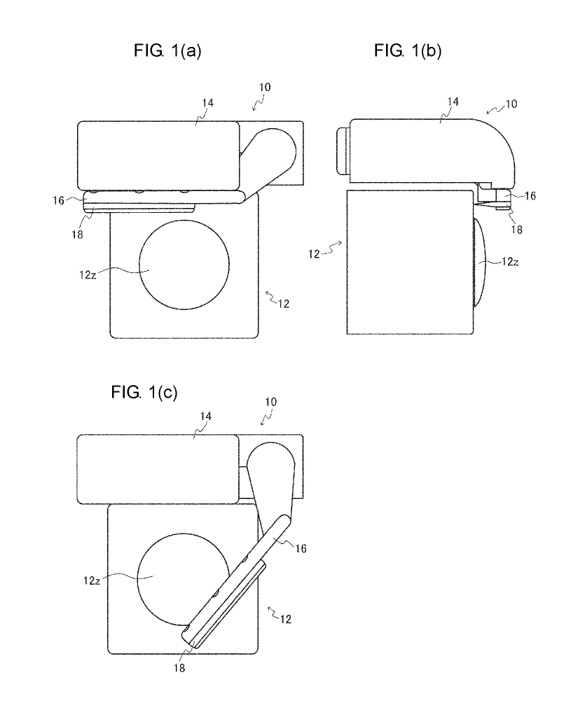

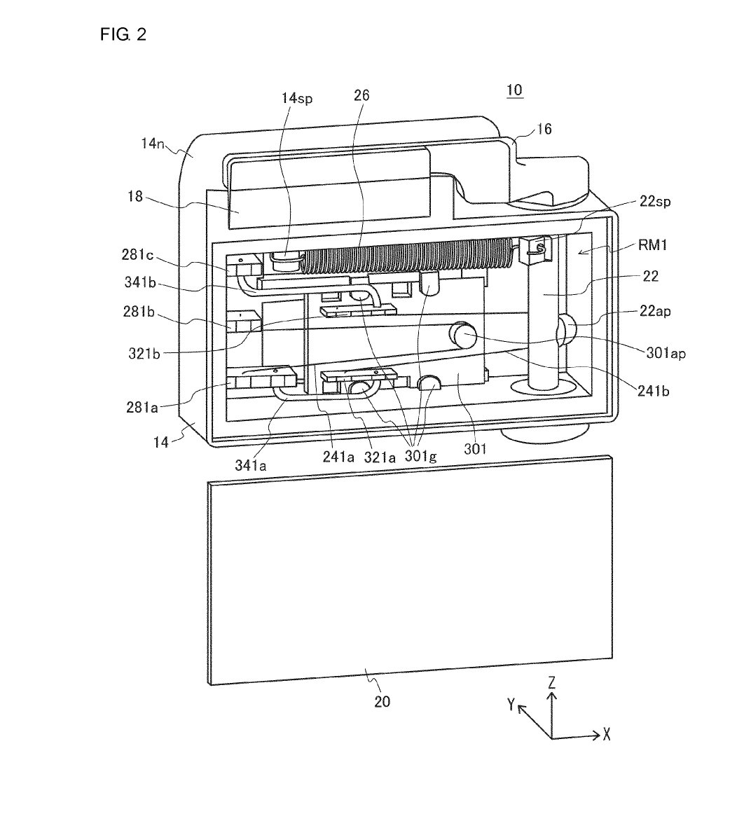

As shown in FIGS. 1(A) through 1(C) and FIG. 2, a raindrop removing device 10 of a first embodiment is a device that is provided in a rear section of an automobile along with a camera 12 so as to remove raindrops attached to a lens 12z, and includes a housing 14 in which a rectangular parallelepiped storage room RM1 is formed. In the case where an X-axis is assigned to a width direction of the housing 14, a Y-axis is assigned to a thickness direction of the housing 14, and a Z-axis (reference axis) is assigned to a height direction of the housing 14, the storage room RM1 is open to a negative side of the Y-axis direction. Two inner side surfaces opposing each other and constituting the storage room RM1 are orthogonal to the X-axis or Z-axis, and a bottom surface also constituting the storage room RM1 is orthogonal to the Y-axis. Further, two outer side surfaces facing opposite sides to each other and constituting the housing 14 are orthogonal to the X-axis or Z-axis.

A cover 20 has a main surface whose size is substantially the same as that of a main surface of the housing 14, and is formed in a plate-like shape. In the case where the cover 20 is set covering the housing 14 from the negative side of the Y-axis direction while taking a posture in which side surfaces of the cover 20 are flush with the outer side surfaces of the housing 14, the storage room RM1 is sealed with the cover 20.

Hereinafter, for purposes of explanation of the exemplary embodiments only, of the outer side surfaces of the housing 14, a surface facing a positive side of the X-axis direction and a surface facing a negative side of the X-axis direction can be considered as an “X-axis positive outer side surface” and an “X-axis negative outer side surface”, respectively, while a surface facing a positive side of the Z-axis direction and a surface facing a negative side of the Z-axis direction can be considered as a “Z-axis positive outer side surface” and a “Z-axis negative outer side surface”, respectively.

Further, for purposes of explanation of the exemplary embodiments only, of the inner side surfaces of the housing 14, a surface opposite to the X-axis positive outer side surface and a surface opposite to the X-axis negative outer side surface can be considered as an “X-axis negative inner side surface” and an “X-axis positive inner side surface”, respectively, while a surface opposite to the Z-axis positive outer side surface and a surface opposite to the Z-axis negative outer side surface can be considered as a “Z-axis negative inner side surface” and a “Z-axis positive inner side surface”, respectively.

Furthermore, a wall constituted by the X-axis positive outer side surface and the X-axis negative inner side surface is defined as an “X-axis positive side wall”, and a wall constituted by the X-axis negative outer side surface and the X-axis positive inner side surface is defined as an “X-axis negative side wall”. In addition, a wall constituted by the Z-axis positive outer side surface and the Z-axis negative inner side surface is defined as a “Z-axis positive side wall”, and a wall constituted by the Z-axis negative outer side surface and the Z-axis positive inner side surface is defined as a “Z-axis negative side wall”.

A rotational shaft 22 is so mounted in the housing 14 as to extend along the Z-axis in the vicinity of the X-axis positive side wall inside the storage room RM1. Note that the rotational shaft 22 has a length exceeding a height of the housing 14. One end of the rotational shaft 22 passes through the Z-axis positive side wall of the housing 14 and protrudes to the outer side portion of the housing 14, while the other end of the rotational shaft 22 passes through the Z-axis negative side wall of the housing 14 and protrudes to the outer side portion of the housing 14. In other words, the rotational shaft 22 is so supported by the housing 14 as to be capable of rotating around the Z-axis.

Hereinafter, a rotation direction of the rotational shaft 22 which is equivalent to a clockwise direction when viewed from the negative side of the Z-axis direction is defined as a “positive rotation direction”, while a rotation direction of the rotational shaft 22 which is equivalent to a counterclockwise direction when viewed from the negative side of the Z-axis direction is defined as a “counter rotation direction”.

A wiper 16 extending in a radial direction of the rotational shaft 22 is provided at the one end of the rotational shaft 22. In an exemplary aspect, a blade 18 can be made of rubber and can be attached to an arm portion of the wiper 16 while extending in the radial direction of the rotational shaft 22, and slides on a surface of the lens 12z in the manner as shown in FIGS. 1(A) through 1(C). A revolving angle of the wiper 16 changes following the rotation of the rotational shaft 22, and raindrops attached to the lens 12z are removed by the blade 18.

A nose 14n is integrally formed on the Z-axis positive outer side surface of the housing 14. When the rotational shaft 22 is rotated in the counter rotation direction, the wiper 16 makes contact with the nose 14n. This design causes the revolution of the wiper 16 in the counter rotation direction to be restricted, and the wiper 16 is protected from an unexpected outer force. An upper limit of the angle at which the rotational shaft 22 can perform counter rotation is smaller than an angle corresponding to a maximum amount of deformation in which shape memory alloys 241a and 241b, which will be explained later, can repeat the transformation.

An SMA post 22ap protruding in the radial direction is integrally formed on the rotational shaft 22 at a certain position (=an approximately central position) inside the storage room RM1. Further, a spring post 22sp protruding in the radial direction is integrally formed on the rotational shaft 22 at another position (=a position in the vicinity of the Z-axis positive side wall) inside the storage room RM1. In addition, a spring post 14sp paired with the spring post 22sp is integrally formed in the housing 14. To be specific, the spring post 14sp protrudes from the Z-axis positive side wall of the storage room RM1 toward the negative side of the Z-axis direction so as to be provided at substantially the same height position as that of the spring post 22sp in the Z-axis direction and in the vicinity of the X-axis negative side wall.

One end of a bias spring (tension coil spring) 26 is caught by the spring post 22sp, while the other end thereof is caught by the spring post 14sp. As a result, an external force in the counter rotation direction is applied to the rotational shaft 22 by the bias spring 26.

Power supply terminals 281a through 281c are fixedly provided in the vicinity of the X-axis negative side wall on a bottom surface of the storage room RM1. In this case, the power supply terminals 281a through 281c are aligned in that order from the negative side toward the positive side of the Z-axis direction, and are extended to the Y-axis positive outer side surface of the housing 14. Further, substantially at the center of the bottom surface of the storage room RM1, there is provided a plate-like relay member 301. The size of a main surface of the relay member 301 is smaller than the size of the bottom surface of the storage room RM1. Guides 301g support the relay member 301 so that the relay member 301 can slide in the X-axis direction in a state in which one main surface of the relay member 301 opposes the bottom surface of the storage room RM1.

On the other main surface of the relay member 301, there are provided relay terminals (specific power supply terminals) 321a and 321b, and an SMA post 301ap. To be more specific, the relay terminal 321a is provided in a position on the negative side of the X-axis direction and also on the negative side of the Z-axis direction, the relay terminal 321b is provided in a position on the negative side of the X-axis direction and also on the positive side of the Z-axis direction, and the SMA post 301ap is provided in a position on the positive side of the X-axis direction and also at the center in the Z-axis direction. The relay terminal 321a is connected to the power supply terminal 281a with a lead wire 341a, and the relay terminal 321b is connected to the power supply terminal 281c with a lead wire 341b.

The shape memory alloy 241a is formed in a wire-like shape, and one end and the other end thereof are connected to the power supply terminals 281a and 281b, respectively. A central portion in a lengthwise direction of the shape memory alloy 241a is hooked on the SMA post 301ap. The shape memory alloy 241b is also formed in a wire-like shape, and one end and the other end thereof (each of which is a specific power supply position) are connected to the relay terminals 321a and 321b, respectively. A central portion in the lengthwise direction of the shape memory alloy 241b is folded back, after passing through a portion between the rotational shaft 22 and the bottom surface of the storage room RM1, to the negative side of the Y-axis direction at a position on the positive side of the X-axis direction relative to the rotational shaft 22, and then is hooked on the SMA post 22ap.

Each of the shape memory alloys 214a and 241b having been hooked as described above forms a substantially U shape when viewed in the Y-axis direction. In addition, the shape memory alloys 214a and 241b partially overlap with each other when viewed in the Z-axis direction.

In the present embodiment, the power supply terminals 281a through 281c, the relay terminals 321a and 321b, and the lead wires 341a and 341b connected in the manner collectively form a power supply system for the removing device 10. Because the shape memory alloys 241a and 241b are connected to the power supply system in the manner described above, power is separately supplied to three or more mutually different positions of the shape memory alloys 241a and 241b.

Here, characteristics of the shape memory alloys 241a and 241b will be briefly described. At a temperature equal to or lower than the transformation temperature, only lattice deformation occurs without the coupling of atoms forming crystal lattices of the shape memory alloys 241a and 241b being cut. As such, when the temperature is equal to or lower than the transformation temperature, in the case where a load of magnitude that will not cut the coupling among the atoms is applied to the shape memory alloys 241a and 241b in the lengthwise direction thereof, an approximately 6% distortion is produced due to the lattice deformation, thereby the shape memory alloys 241a and 241b will expand. In the case where the shape memory alloys 241a and 241b are heated to a temperature higher than the transformation temperature, the lattice deformation is resolved and the lengths of the shape memory alloys 241a and 241b are shortened.

When power is not being supplied to any of the power supply terminals 281a through 281c, because an external force in the counter rotation direction is applied to the rotational shaft 22 by the bias spring 26, the relay member 301 slides toward the positive side of the X-axis direction, and the shape memory alloys 241a, 241b experience lattice deformation at a temperature equal to or lower than the transformation temperature so as to be expanded. When the wiper 16 makes contact with the nose 14n, further rotation of the rotational shaft 22, that is, the revolution of the wiper 16 is restricted.

When power supply to the power supply terminals 281a and 281b begins, a current is supplied to the shape memory alloy 241a. The shape memory alloy 241a is caused to perform self-heating by Joule heat, and the lattice deformation is resolved when the temperature of the shape memory alloy 241a exceeds the transformation temperature. Heat shrinkage occurs in the shape memory alloy 241a, which causes the relay member 301 to slide toward the negative side of the X-axis direction. As a result, the rotational shaft 22 rotates in the positive rotation direction so that the wiper 16 revolves in the positive rotation direction.

When the power supply to the power supply terminals 281a and 281b is stopped, the shape memory alloy 241a is naturally cooled. In the case where the temperature of the shape memory alloy 241a becomes lower than the transformation temperature, lattice deformation is produced by a biasing force of the bias spring 26, thereby the shape memory alloy 241a expands. As a result, the relay member 301 slides toward the positive side of the X-axis direction and the rotational shaft 22 rotates in the counter rotation direction. The wiper 16 revolves in the counter rotation direction along with the rotation of the rotational shaft 22.

When power is supplied to the power supply terminals 281a and 281c, a current is supplied to the shape memory alloy 241b. The shape memory alloy 241b the performs self-heating by Joule heat, and the lattice deformation is resolved when the temperature of the shape memory alloy 241b exceeds the transformation temperature. Heat shrinkage occurs in the shape memory alloy 241b, which causes the rotational shaft 22 to rotate in the positive rotation direction and the wiper 16 to revolve in the positive rotation direction.

When the power supply to the power supply terminals 281a and 281c is stopped, the shape memory alloy 241b is naturally cooled. In the case where the temperature of the shape memory alloy 241b becomes lower than the transformation temperature, lattice deformation is produced by an elastic force of the bias spring 26, thereby the shape memory alloy 241b being expanded. As a result, the rotational shaft 22 rotates in the counter rotation direction and the wiper 16 revolves in the counter rotation direction.

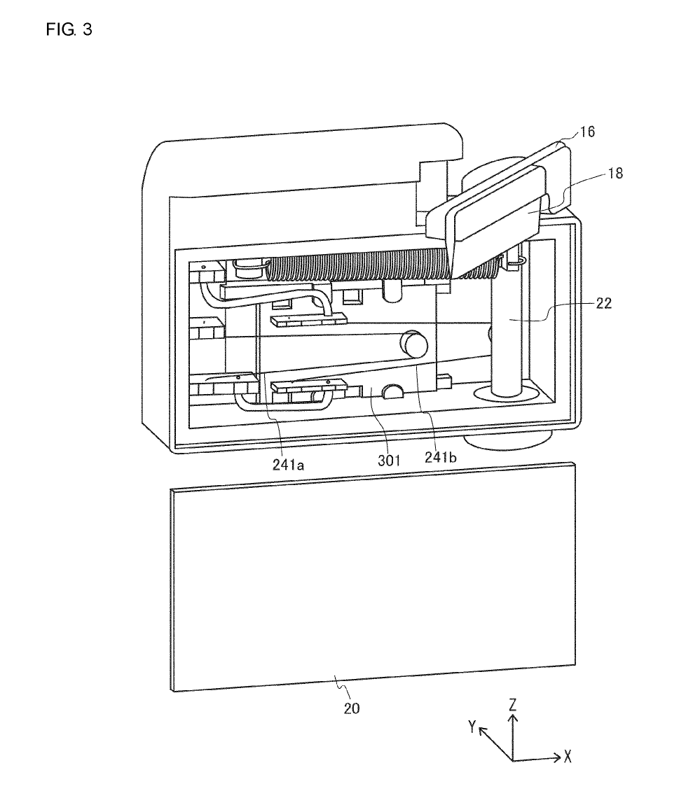

As such, in the case where both the shape memory alloys 241a and 241b shrink, the relay member 301 slides toward the negative side of the X-axis direction and the rotational shaft 22 rotates in the positive rotation direction, as shown in FIG. 3. An angle equivalent to an amount of sliding movement of the relay member 301 is added to the rotation angle of the rotational shaft 22, and the wiper 16 revolves up to the maximum angle. On the other hand, in the case where only one of the shape memory alloys 241a and 241b shrinks, the revolving angle of the wiper 16 is smaller than the maximum angle. In other words, the revolving angle of the wiper 16 is changed in stages by switching the modes of power supply to the power supply terminals 281a through 281c.

The shape memory alloys 241a and 241b are an alloy made of Ni/Ti and the like. The materials of the rotational shaft 22, the wiper 16, the spring posts 14sp and 22sp, and the SMA post 22ap are a metal such as aluminum, a resin such as PPS (polyphenylene sulfide), and the like. Further, the bias spring 26 is formed of a spring member such as stainless steel or the like, and the material of the blade 18 is natural rubber, synthetic rubber, or the like. The materials of the power supply terminals 281a through 281c, the relay terminals 321a and 321b, and the lead wires 341a and 341b are a conductor such as copper, brass, aluminum, or the like. The materials of the housing 14, the cover 20, the relay member 301, and the SMA post 301ap are a resin such as PPS or the like.

As can be understood from the above discussion, the rotational shaft (revolving member) 22 is so supported by the housing 14 as to be capable of revolving in each of the positive rotation direction (first direction) and the counter rotation direction (second direction) which can be considered around the Z-axis (reference axis) as shown. The shape memory alloys 241a and 241b formed in a wire-like shape (linear shape) apply an external force acting in the positive rotation direction to the rotational shaft 22 by the heat shrinkage. The bias spring (elastic body) 26 applies an external force acting in the counter rotation direction to the rotational shaft 22. The wiper (target member) 16 is displaced following the rotation of the rotational shaft 22. The power supply system formed by the power supply terminals 281a through 281c, the relay terminals 321a and 321b, and the lead wires 341a and 341b, supplies power separately to three or more mutually different positions of the shape memory alloys 241a and 241b.

Forming the shape memory alloys 241a and 241b in a linear shape causes the force produced by the lattice deformation to directly act as a shrinkage force, thereby making it possible to obtain a large force. This means that the shape memory alloys 241a and 241b can be made to be thin. This design enables the heat capacitance to be smaller so that the power consumption for the current supply can be suppressed. Moreover, because the time of natural cooling is shortened, an interval of repetitive operations is shortened and the response characteristics of the shape memory alloys 241a and 241b with respect to the current supply are improved.

By separately supplying power to three or more mutually different positions of the shape memory alloys 241a and 241b, the shape memory alloys 241a and 241b shrink in different amounts from each other in accordance with the power supply modes. This makes it possible to appropriately change the revolving angle of the wiper 16. Raindrops attached to the blade 18 are favorably shaken off through irregularly changing the revolving angle.

By providing the relay member 301 between the rotational shaft 22 and the power supply terminals 281a through 281c and arranging the positions of the relay terminals 321a and 321b for current supply to the shape memory alloy 241b on the side of the power supply terminals 281a through 281c relative to the SMA post 301ap on which the shape memory alloy 241a is hooked, the revolving angle of the wiper 16 can be increased without changing a distance from the rotational shaft 22 to the power supply terminals 281a through 281c when the currents are simultaneously supplied to the shape memory alloys 241a and 241b. This makes it possible to miniaturize the housing 14.

Although, in the present embodiment, a tension coil spring is employed as the bias spring 26, an elastic body such as a plate spring, a tension spring, rubber, or the like may be employed as long as the stated elastic body can apply the external force acting in the counter rotation direction to the rotational shaft 22. Further, in the present embodiment, although the rotational shaft 22 is formed in a circular cylinder shape, the rotational shaft 22 may be formed in an elliptic cylinder shape, a prism shape, or the like.

### Second Embodiment

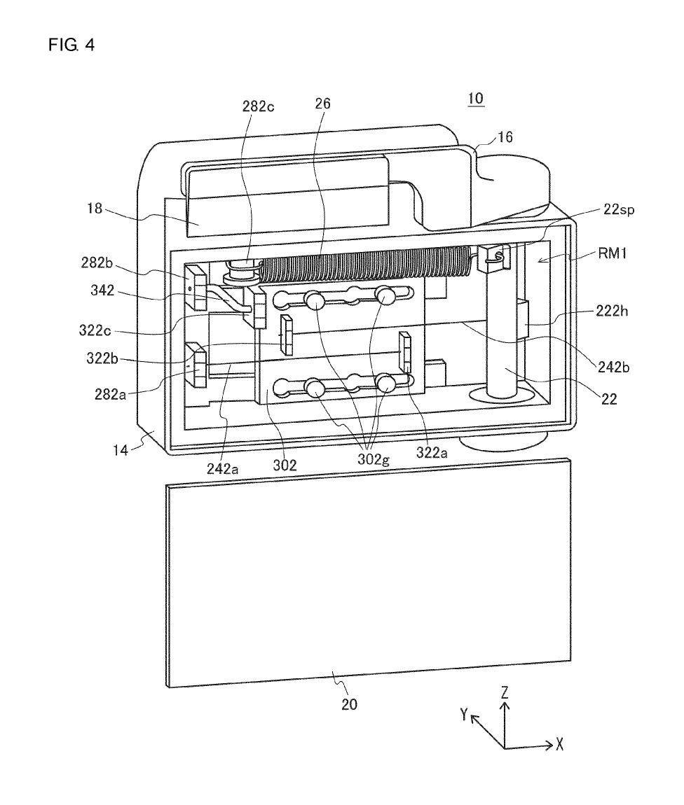

As shown in FIG. 4, a raindrop removing device 10 of a second embodiment, when compared to the raindrop removing device 10 shown in FIG. 2, employs an SMA holding member 222h in place of the SMA post 22ap, shape memory alloys 242a and 242b in place of the shape memory alloys 241a and 241b, power supply terminals 282a through 282c in place of the power supply terminals 281a through 281c, a relay member 302 in place of the relay member 301, guides 302g in place of the guides 301g, relay terminals (specific power supply terminals) 322a through 322c in place of the relay terminals 321a and 321b, and a lead wire 342 in place of the lead wires 341a and 341b. Further, the materials of the relay member 302, the SMA holding member 222h, the rotational shaft 22, and the spring post 22sp are a metal such as aluminum or the like (a conductor in which plating or the like is performed on a surface of a resin such as PPS or the like may also be used). The bias spring 26 is formed of a spring member such as stainless steel or the like.

Accordingly, hereinafter, different points from the raindrop removing device 10 shown in FIG. 2 will be mainly described and redundant description on the same constituent elements will be omitted as much as possible.

The SMA holding member 222h is integrally formed on the rotational shaft 22 so as to protrude in the radial direction at a certain position (=an approximately central position) inside the storage room RM1.

The power supply terminals 282a and 282b are fixedly provided in the vicinity of the X-axis negative side wall on the bottom surface of the storage room RM1. The power supply terminal 282c has substantially the same shape as the spring post 14sp shown in FIG. 2 and is fixedly provided in the same position as that of the spring post 14sp. The power supply terminals 282a and 282b are aligned in that order from the negative side toward the positive side of the Z-axis direction. Further, all of the power supply terminals 282a through 282c are extended to the Y-axis positive outer side surface of the housing 14.

The relay member 302 is formed in a plate-like shape and is provided substantially at the center of the bottom surface of the storage room RM1. The size of a main surface of the relay member 302 is also smaller than the size of the bottom surface of the storage room RM1. The guides 302g support the relay member 302 so that the relay member 302 can slide in the X-axis direction in a state in which one main surface of the relay member 302 opposes the bottom surface of the storage room RM1.

The relay terminals 322a and 322b are integrally formed on the other main surface of the relay member 302, while the relay terminal 322c is integrally formed on a side surface of the relay member 302. Here, the forming position of the relay terminal 322a is a position in the other main surface on the positive side of the X-axis direction and also on the negative side of the Z-axis direction. Further, the forming position of the relay terminal 322b is a position in the other main surface on the negative side of the X-axis direction and also on the positive side of the Z-axis direction. Furthermore, the side surface where the relay terminal 322c is formed is a side surface, among four side surfaces constituting the relay member 302, that faces the negative side of the X-axis direction.

A height position of the relay terminal 322a is substantially the same as that of the power supply terminal 282a, a height position of the relay terminal 322b is substantially the same as that of the SMA holding member 222h, and a height position of the relay terminal 322c is substantially the same as that of the power supply terminal 282b. The relay terminal 322c is connected to the power supply terminal 282b with the lead wire 342.

Each of the shape memory alloys 242a and 242b is formed in a wire-like shape. Among them, one end and the other end (specific power supply position) of the shape memory alloy 242a are connected to the power supply terminal 282a and the relay terminal 322a, respectively. Further, one end (specific power supply position) and the other end of the shape memory alloy 242b are connected to the relay terminal 322b and the SMA holding member 222h, respectively. In particular, the other end of the shape memory alloy 242b passes through a portion between the rotational shaft 22 and the bottom surface of the housing 14 and then is connected to the SMA holding member 222h. The shape memory alloys 242a and 242b respectively connected in the manner as discussed above extend in parallel to the X-axis and partially overlap with each other when viewed in the Z-axis direction.

In the present embodiment, the power supply terminals 282a through 282c, the relay member 302, the relay terminals 322a through 322c, and the lead wire 342 connected in the manner as described above can collectively form a “power supply system” according to an exemplary embodiment. Because the shape memory alloys 242a and 242b are connected to the power supply system in the manner described above, power is separately supplied to three or more mutually different positions of the shape memory alloys 242a and 242b.

An external force in the counter rotation direction is applied to the rotational shaft 22 by the bias spring 26. As such, in a state where power is not being supplied to any of the power supply terminals 282a through 282c, the relay member 302 slides toward the positive side of the X-axis direction, and the shape memory alloys 242a, 242b experience lattice deformation at a temperature equal to or lower than the transformation temperature so as to be expanded. As a result, the wiper 16 revolves in the counter rotation direction and stops at a position where the wiper 16 makes contact with the nose 14n.

Upon power supply to the power supply terminals 282a and 282b being started, a current is supplied to the shape memory alloy 242a so that the shape memory alloy 242a performs self-heating. The heat shrinkage occurs in the shape memory alloy 242a, which causes the relay member 302 to slide toward the negative side of the X-axis direction. The rotational shaft 22 rotates in the positive rotation direction so that the wiper 16 revolves in the positive rotation direction.

When the power supply to the power supply terminals 282a and 282b is stopped, the shape memory alloy 242a is naturally cooled. When the temperature of the shape memory alloy 242a becomes lower than the transformation temperature, lattice deformation is produced by the biasing force of the bias spring 26, thereby the shape memory alloy 242a being expanded. As a result, the relay member 302 slides toward the positive side of the X-axis direction and the rotational shaft 22 rotates in the counter rotation direction. The wiper 16 revolves in the counter rotation direction along with the rotation of the rotational shaft 22.

Upon power supply to the power supply terminals 282b and 282c being started, a current is supplied to the shape memory alloy 242b so that the shape memory alloy 242b performs self-heating. The heat shrinkage occurs in the shape memory alloy 242b, which causes the rotational shaft 22 to rotate in the positive rotation direction and the wiper 16 to revolve in the positive rotation direction.

When the power supply to the power supply terminals 282b and 282c is stopped, the shape memory alloy 242b is naturally cooled. When the temperature of the shape memory alloy 242b becomes lower than the transformation temperature, lattice deformation is produced by the biasing force of the bias spring 26, thereby the shape memory alloy 242b being expanded. As a result, the rotational shaft 22 rotates in the counter rotation direction and the wiper 16 revolves in the counter rotation direction.

As such, when both the shape memory alloys 242a and 242b shrink, the wiper 16 revolves up to the maximum angle; when only one of the shape memory alloys 242a and 242b shrinks, the wiper 16 revolves to an angle smaller than the maximum angle. In other words, the revolving angle of the wiper 16 is changed in stages by switching the modes of power supply to the power supply terminals 282a through 282c.

Also in the present embodiment, by forming the shape memory alloys 242a and 242b in a linear shape, the power consumption for current supply can be suppressed, and the response characteristics of the shape memory alloys 242a and 242b with respect to the current supply are improved. Further, by separately supplying power to three or more mutually different positions of the shape memory alloys 242a and 242b, the revolving angle of the wiper 16 can be appropriately changed. Raindrops attached to the blade 18 are favorably shaken off through irregularly changing the revolving angle.

Moreover, by providing the relay member 302 between the rotational shaft 22 and the power supply terminals 282a through 282c and arranging the position of the relay terminal 322b for current supply to the shape memory alloy 242b on the side of the power supply terminals 282a through 282c relative to the relay terminal 322a for current supply to the shape memory alloy 242a, the revolving angle of the wiper 16 can be made larger without changing a distance from the rotational shaft 22 to the power supply terminals 282a through 282c when the currents are simultaneously supplied to the shape memory alloys 242a and 242b. This makes it possible to miniaturize the housing 14.

The structure in which each of the shape memory alloys 242a and 242b is provided in a straight line, like in the present embodiment, contributes to a reduction in the amount of used shape memory alloys, an increase in displacement per unit amount of the shape memory alloy, and simplification of the structure. The stated structure is preferably employed when the driving force of the wiper 16 is allowed to be small.

### Third Embodiment

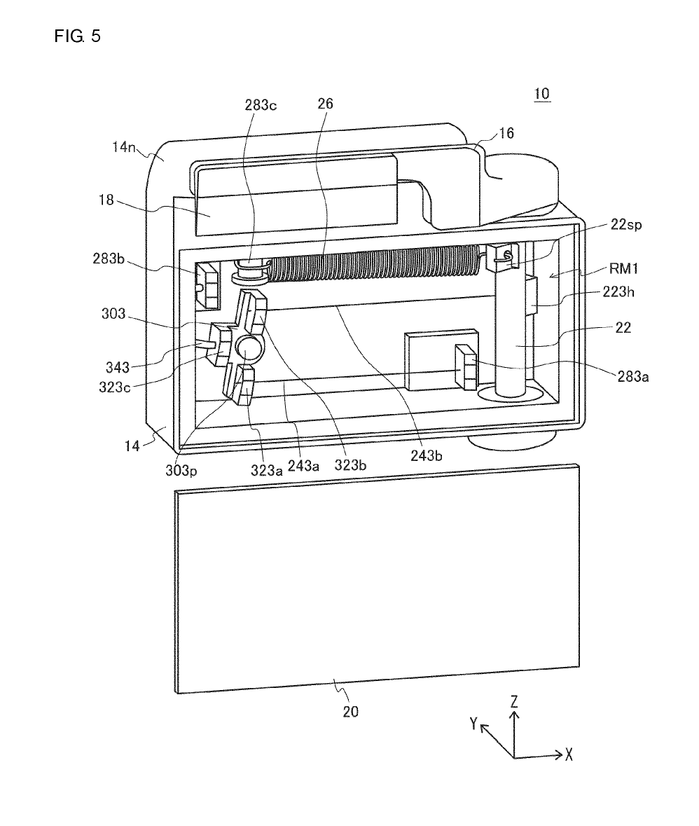

As shown in FIG. 5, a raindrop removing device 10 of a third embodiment, when compared to the raindrop removing device 10 shown in FIG. 2, employs an SMA holding member 223h in place of the SMA post 22ap, shape memory alloys 243a and 243b in place of the shape memory alloys 241a and 241b, power supply terminals 283a through 283c in place of the power supply terminals 281a through 281c, a relay member 303 in place of the relay member 301, a pin 303p in place of the guides 301g, relay terminals (specific power supply terminals) 323a through 323c in place of the relay terminals 321a and 321b, and a lead wire 343 in place of the lead wires 341a and 341b. Further, the materials of the relay member 303, the SMA holding member 223h, the rotational shaft 22, and the spring post 22sp are a metal such as aluminum or the like (a conductor in which plating or the like is performed on a surface of a resin such as PPS or the like may also be used). The bias spring 26 is formed of a spring member such as stainless steel or the like.

Accordingly, hereinafter, different points from the raindrop removing device 10 shown in FIG. 2 will be mainly described and redundant description on the same constituent elements will be omitted as much as possible.

The SMA holding member 223h is integrally formed on the rotational shaft 22 so as to protrude in the radial direction at a certain position inside the storage room RM1.

The power supply terminal 283a is fixedly provided in the vicinity of the Z-axis negative side wall and also in the vicinity of the rotational shaft 22 on the bottom surface of the storage room RM1. The power supply terminal 283b is fixedly provided in the vicinity of a corner formed by the X-axis negative side wall and the Z-axis positive side wall on the bottom surface of the storage room RM1. The power supply terminal 283c has substantially the same shape as the spring post 14sp shown in FIG. 2 and is fixedly provided in the same position as that of the spring post 14sp. All of the power supply terminals 283a through 283c provided in the manner as discussed above are extended to the Y-axis positive outer side surface of the housing 14.

The relay member 303 is provided in a position on the negative side of the Z-axis direction relative to the power supply terminal 283c on the bottom surface of the storage room RM1. To be more specific, the relay member 303 is attached to the bottom surface of the storage room RM1 with the pin 303p formed in a cylinder shape and extending in the Y-axis direction, and is capable of revolving about an axis direction of the pin 303p.

Each of the relay terminals 323a and 323b is integrally formed on the relay member 303 so as to be extended in the radial direction of the pin 303p. In this case, the extending direction of the relay terminal 323b forms an angle of 180 degrees with respect to the extending direction of the relay terminal 323a. The relay terminal 323c is integrally formed on the relay member 303 so as to be extended in parallel to each of the relay terminals 323a and 323b. Further, the relay terminal 323c is connected to the power supply terminal 283b with the lead wire 343.

Each of the shape memory alloys 243a and 243b is formed in a wire-like shape. Among them, one end (specific power supply position) and the other end of the shape memory alloy 243a are connected to the relay terminal 323a and the power supply terminal 283a, respectively. Further, one end (specific power supply position) and the other end of the shape memory alloy 243b are connected to the relay terminal 323b and the SMA holding member 223h, respectively. The shape memory alloys 243a and 243b respectively connected in the manner as discussed above extend in parallel to the X-axis and partially overlap with each other when viewed in the Z-axis direction.

In the present embodiment, the power supply terminals 283a through 283c, the relay member 303, the relay terminals 323a through 323c, and the lead wire 343 connected in the manner as described above can collectively form a “power supply system” according to an exemplary embodiment. Because the shape memory alloys 243a and 243b are connected to the power supply system in the manner described above, power is separately supplied to three or more mutually different positions of the shape memory alloys 243a and 243b.

An external force in the counter rotation direction is applied to the rotational shaft 22 by the bias spring 26. As such, in a state where power is not being supplied to any of the power supply terminals 283a through 283c, the relay member 303 revolves so that the relay terminal 323b moves toward the positive side of the X-axis direction, and the shape memory alloys 243a, 243b experience lattice deformation at a temperature equal to or lower than the transformation temperature so as to be expanded. As a result, the wiper 16 revolves in the counter rotation direction and stops at a position where the wiper 16 makes contact with the nose 14n.

Upon power supply to the power supply terminals 283a and 283b being started, a current is supplied to the shape memory alloy 243a. The heat shrinkage occurs in the shape memory alloy 243a, which causes the relay member 303 to revolve so that the relay terminal 323a moves toward the positive side of the X-axis direction. The rotational shaft 22 rotates in the positive rotation direction and the wiper 16 revolves in the positive rotation direction.

When the power supply to the power supply terminals 283a and 283b is stopped, the shape memory alloy 243a is naturally cooled. When the temperature of the shape memory alloy 243a becomes lower than the transformation temperature, lattice deformation is produced by the biasing force of the bias spring 26, thereby the shape memory alloy 243a being expanded. As a result, the relay member 303 revolves so that the relay terminal 323b moves toward the positive side of the X-axis direction. The rotational shaft 22 rotates in the counter rotation direction, and the wiper 16 revolves in the counter rotation direction following the rotation of the rotational shaft 22.

Upon power supply to the power supply terminals 283b and 283c being started, a current is supplied to the shape memory alloy 243b. The heat shrinkage occurs in the shape memory alloy 243b, which causes the rotational shaft 22 to rotate in the positive rotation direction and the wiper 16 to revolve in the positive rotation direction.

When the power supply to the power supply terminals 283b and 283c is stopped, the shape memory alloy 243b is naturally cooled. When the temperature of the shape memory alloy 243b becomes lower than the transformation temperature, lattice deformation is produced by the biasing force of the bias spring 26, thereby the shape memory alloy 243b being expanded. As a result, the rotational shaft 22 rotates in the counter rotation direction and the wiper 16 revolves in the counter rotation direction.

Accordingly, when both the shape memory alloys 243a and 243b shrink, the wiper 16 revolves up to the maximum angle; when only one of the shape memory alloys 243a and 243b shrinks, the wiper 16 revolves to an angle smaller than the maximum angle. In other words, the revolving angle of the wiper 16 is changed in stages by switching the modes of power supply to the power supply terminals 283a through 283c.

Also in the present embodiment, by forming the shape memory alloys 243a and 243b in a linear shape, the power consumption for current supply can be suppressed, and the response characteristics of the shape memory alloys 243a and 243b with respect to the current supply can be improved. Further, by separately supplying power to three or more mutually different positions of the shape memory alloys 243a and 243b, the revolving angle of the wiper 16 can be appropriately changed.

Further, the housing 14 can be miniaturized by providing the relay terminals 323a and 323b on the relay member 303 which is attached with the pin 303p to be capable of revolving, and arranging the shape memory alloys 243a and 243b in parallel to each other with the relay terminals 323a, 323b interposed therebetween. Furthermore, arranging each of the shape memory alloys 243a and 243b in a straight line makes it possible to reduce the amount of used shape memory alloys and simplify the structure.

The revolving angle of the wiper 16 can be adjusted by changing a ratio between a length from the pin 303p to the relay terminal 323a and a length from the pin 303p to the relay terminal 323b.

### Fourth Embodiment

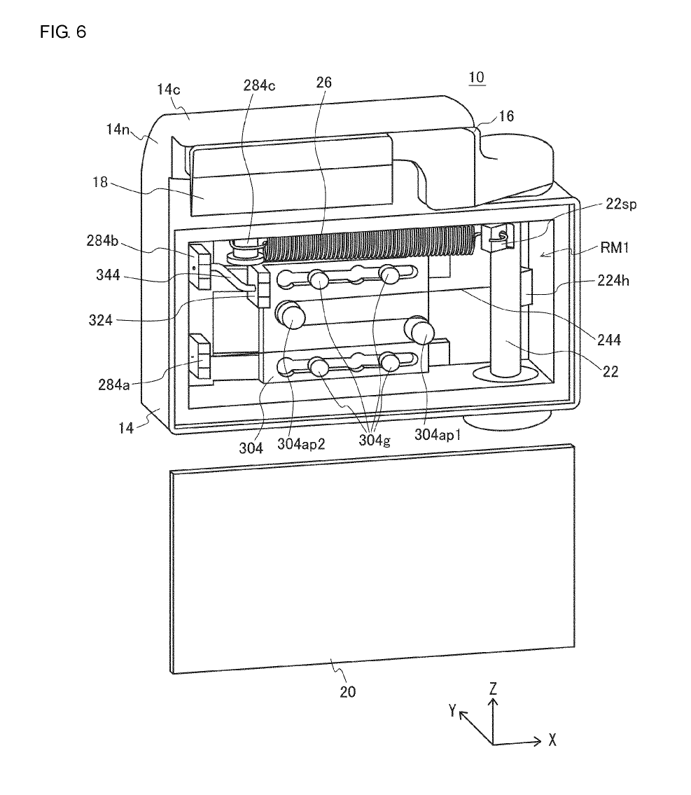

As shown in FIG. 6, in a raindrop removing device 10 of a fourth embodiment, when compared to the raindrop removing device 10 shown in FIG. 4, an arm cover 14c is additionally provided on the nose 14n, SMA posts 304ap1 and 304ap2 are employed in place of the relay terminals 322a and 322b, and a shape memory alloy 244 is employed in place of the shape memory alloys 242a and 242b.

Note that an SMA holding member 224h shown in FIG. 6 is the same as the SMA holding member 222h shown in FIG. 4, and power supply terminals 284a through 284c shown in FIG. 6 are the same as the power supply terminals 282a through 282c shown in FIG. 4. Further, a relay member 304 shown in FIG. 6 is the same as the relay member 302 shown in FIG. 4, and guides 304g shown in FIG. 6 are the same as the guides 302g shown in FIG. 4. Furthermore, a relay terminal (specific power supply terminal) 324 shown in FIG. 6 is the same as the relay terminal 322c shown in FIG. 4, and a lead wire 344 shown in FIG. 6 is the same as the lead wire 342 shown in FIG. 4.

The materials of the relay member 304, the SMA holding member 224h, the rotational shaft 22, the spring post 22sp, and the SMA posts 304ap1 and 304ap2 are a metal such as aluminum or the like (a conductor in which plating or the like is performed on a surface of a resin such as PPS or the like may also be used), like in the case of the raindrop removing device 10 shown in FIG. 4. Further, the bias spring 26 is formed of a spring member such as stainless steel or the like.

Accordingly, hereinafter, different points from the raindrop removing device 10 shown in FIG. 4 will be mainly described and redundant description on the same constituent elements will be omitted as much as possible.

The arm cover 14c is provided on an end portion of the nose 14n on the positive side of the Z-axis direction, and extends along the X-axis direction. When the raindrop removing device 10 is viewed from the positive side of the Z-axis direction in a state where the wiper 16 is in contact with the nose 14n, the arm portion of the wiper 16 is covered by the arm cover 14c. The arm portion of the wiper 16 is protected from an unexpected external force from the positive side of the Z-axis direction.

The SMA posts 304ap1 and 304ap2 are integrally formed on the other main surface of the relay member 304. Here, the forming position of the SMA post 304ap1 is a position in the other main surface on the positive side of the X-axis direction and also on the negative side of the Z-axis direction. Further, the forming position of the SMA post 304ap2 is a position in the other main surface on the negative side of the X-axis direction and also on the positive side of the Z-axis direction. A height position of the SMA post 304ap1 is substantially the same as that of the power supply terminal 284a, while a height position of the SMA post 304ap2 is substantially the same as that of the SMA holding member 224h.

The shape memory alloy 244 is formed in a wire-like shape. One end thereof is connected to the power supply terminal 284a, while the other end thereof is connected to the SMA holding member 224h through the SMA post 304ap1 and the SMA post 304ap2. To be more specific, when the power supply terminal 284a is taken as a starting point, the shape memory alloy 244 extends toward the positive side of the X-axis direction, and is folded back to the negative side of the X-axis direction at the SMA post 304ap1. The shape memory alloy 244 having been folded back is folded back again to the positive side of the X-axis direction at the SMA post 304ap2, and thereafter is connected to the SMA holding member 224h. Accordingly, the shape memory alloy 244 extends in a zigzag pattern when viewed from the negative side of the Y-axis direction.

Note that, hereinafter, of the sections included in the shape memory alloy 244 from the one end to the other end thereof, a section from the one end to a position (specific power supply position) in contact with the SMA post 304ap1 is defined as a “section A1”, and a section from a position in contact with the SMA post 304ap2 to the other end is defined as a “section B1”.

In the present embodiment, the power supply terminals 284a through 284c, the relay member 304, the relay terminal 324, the lead wire 344, and the SMA posts 304ap1, 304ap2 can collectively form a “power supply system” according to an exemplary embodiment. Because the shape memory alloy 244 is connected to the power supply system in the manner described above, power is separately supplied to three or more mutually different positions of the shape memory alloy 244.

An external force in the counter rotation direction is applied to the rotational shaft 22 by the bias spring 26. As such, in a state where power is not being supplied to any of the power supply terminals 284a through 284c, the relay member 304 slides toward the positive side of the X-axis direction, and the shape memory alloy 244 experiences lattice deformation at a temperature equal to or lower than the transformation temperature so as to be expanded. As a result, the wiper 16 revolves in the counter rotation direction and stops at a position where the wiper 16 makes contact with the nose 14n.

Upon power supply to the power supply terminals 284a and 284b being started, the section A1 of the shape memory alloy 244 performs self-heating due to the current supply to the alloy. The heat shrinkage occurs in the section A1 of the shape memory alloy 244, which causes the relay member 304 to slide toward the negative side of the X-axis direction. The rotational shaft 22 rotates in the positive rotation direction and the wiper 16 revolves in the positive rotation direction.

When the power supply to the power supply terminals 284a and 284b is stopped, the section A1 of the shape memory alloy 244 is naturally cooled. When the temperature of the shape memory alloy 244 becomes lower than the transformation temperature in the section A1, lattice deformation is produced by the biasing force of the bias spring 26, thereby the shape memory alloy 244 being expanded. As a result, the relay member 304 slides toward the positive side of the X-axis direction and the rotational shaft 22 rotates in the counter rotation direction. The wiper 16 revolves in the counter rotation direction along with the rotation of the rotational shaft 22.

Upon power supply to the power supply terminals 284b and 284c being started, the section B1 of the shape memory alloy 244 performs self-heating due to the current supply to the alloy. The heat shrinkage occurs in the section B1 of the shape memory alloy 244, which causes the rotational shaft 22 to rotate in the positive rotation direction and the wiper 16 to revolve in the positive rotation direction.

When the power supply to the power supply terminals 284b and 284c is stopped, the section B1 of the shape memory alloy 244 is naturally cooled. When the temperature of the shape memory alloy 244 becomes lower than the transformation temperature, lattice deformation is produced by the biasing force of the bias spring 26, thereby the shape memory alloy 244 being expanded. As a result, the rotational shaft 22 rotates in the counter rotation direction and the wiper 16 revolves in the counter rotation direction.

Accordingly, when all the sections of the shape memory alloy 244 shrink, the wiper 16 revolves up to the maximum angle; when only the section A1 or B1 of the shape memory alloy 244 shrinks, the wiper 16 revolves to an angle smaller than the maximum angle. In other words, the revolving angle of the wiper 16 is changed in stages by switching the modes of power supply to the power supply terminals 284a through 284c.

Also in the present embodiment, by forming the shape memory alloy 244 in a linear shape, the power consumption for current supply can be suppressed, and the response characteristics of the shape memory alloy 244 with respect to the current supply can be improved. Further, by separately supplying power to three or more mutually different positions of the shape memory alloy 244, the revolving angle of the wiper 16 can be appropriately changed.

Further, by providing the relay member 304 between the rotational shaft 22 and the power supply terminals 284a through 284c and arranging the SMA post 304ap2 on the side of the power supply terminals 284a through 284c relative to the SMA post 304ap1, when the currents are simultaneously supplied to the section A1 and section B1, the revolving angle of the wiper 16 can be made larger without changing a distance from the rotational shaft 22 to the power supply terminals 284a through 284c. This makes it possible to miniaturize the housing 14.

Because only a single shape memory alloy 244 is required to be arranged, the raindrop removing device 10 can be assembled with ease. Note that the revolving angle of the wiper 16 can be adjusted by changing a ratio between the length of the section A1 and the length of the section B1.

### Fifth Embodiment

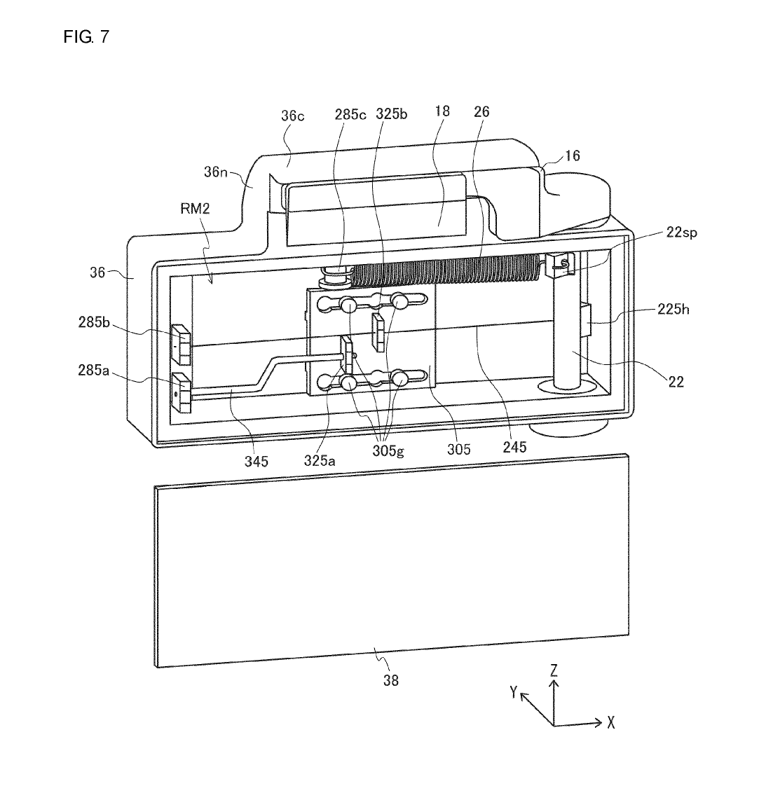

As shown in FIG. 7, a raindrop removing device 10 of a fifth embodiment, when compared to the raindrop removing device 10 shown in FIG. 6, employs a housing 36 having a storage room RM2 in place of the housing 14, a shape memory alloy 245 in place of the shape memory alloy 244, power supply terminals 285a and 285b in place of the power supply terminals 284a and 284b, relay terminals (specific power supply terminals) 325a and 325b in place of the relay terminal 324 and the SMA posts 304ap1 and 304ap2, and a lead wire 345 in place of the lead wire 344.

Note that an SMA holding member 225h is the same as the SMA holding member 224h, a power supply terminal 285c is the same as the power supply terminal 284c, a relay member 305 is substantially the same as the relay member 304, and guides 305g are substantially the same as the guides 304g. The materials of the relay member 305, the SMA holding member 225h, and the rotational shaft 22 are a metal such as aluminum or the like (a conductor in which plating or the like is performed on a surface of a resin such as PPS or the like may also be used). The bias spring 26 is formed of a spring member such as stainless steel or the like.

Accordingly, hereinafter, different points from the raindrop removing device 10 shown in FIG. 6 will be mainly described and redundant description on the same constituent elements will be omitted as much as possible.

Although a thickness and a height of the housing 36 are the same as those of the housing 14, a width of the housing 36 is larger than that of the housing 14. Accordingly, the space of the storage room RM2 is also larger than that of the storage room RM1.

The power supply terminals 285a and 285b are fixedly provided in the vicinity of the X-axis negative side wall on a bottom surface of the storage room RM2. To be specific, the power supply terminals 285a and 285b are aligned in that order from the negative side of the Z-axis direction toward the positive side thereof. A height position of the power supply terminal 285b in the Z-axis direction is the same as that of the SMA holding member 225h. Each of the power supply terminals 285a and 285b is extended to the Y-axis positive outer side surface of the housing 36.

The relay terminals 325a and 325b are integrally formed on the other main surface of the relay member 305. Here, the forming position of the relay terminal 325a is a position which is on the negative side of the X-axis direction relative to the center position of the other main surface and is slightly shifted toward the negative side of the Z-axis direction. The forming position of the relay terminal 325b is a position slightly shifted toward the positive side of the Z-axis direction relative to the center position of the other main surface. A height position of the relay terminal 325b is substantially the same as that of the power supply terminal 285b. The relay terminal 325a is connected to the power supply terminal 285a with the lead wire 345.

The shape memory alloy 245 is formed in a wire-like shape. One end of the shape memory alloy 245 is connected to the power supply terminal 285b, while the other end thereof passes through the relay terminal 325b and then is connected to the SMA holding member 225h. The relay terminal 325b is firmly fixed to the shape memory alloy 245 at the center position in the lengthwise direction of the shape memory alloy 245.

Hereinafter, of the sections included in the shape memory alloy 245 from the one end to the other end thereof, a section from the one end to a position in contact with the relay terminal 325b (specific power supply position) is defined as a “section A2”, and a section from the position in contact with the relay terminal 325b to the other end is defined as a “section B2”.

In the present embodiment, the power supply terminals 285a through 285c, the relay member 305, the relay terminals 325a and 325b, and the lead wire 345 can collectively form a “power supply system” according to an exemplary embodiment. Because the shape memory alloy 245 is connected to the power supply system in the manner described above, power is separately supplied to three or more mutually different positions of the shape memory alloy 245.

An external force in the counter rotation direction is applied to the rotational shaft 22 by the bias spring 26. As such, in a state where power is not being supplied to any of the power supply terminals 285a through 285c, the relay member 305 slides toward the positive side of the X-axis direction, and the shape memory alloy 245 experiences lattice deformation at a temperature equal to or lower than the transformation temperature so as to be expanded. As a result, the wiper 16 revolves in the counter rotation direction and stops at a position where the wiper 16 makes contact with the nose 14n.

Upon power supply to the power supply terminals 285a and 285b being started, the section A2 of the shape memory alloy 245 performs self-heating due to the current supply to the alloy. The heat shrinkage occurs in the section A2 of the shape memory alloy 245, which causes the relay member 305 to slide toward the negative side of the X-axis direction. The rotational shaft 22 rotates in the positive rotation direction and the wiper 16 revolves in the positive rotation direction.

When the power supply to the power supply terminals 285a and 285b is stopped, the section A2 of the shape memory alloy 245 is naturally cooled. When the temperature of the shape memory alloy 245 becomes lower than the transformation temperature in the section A2, lattice deformation is produced by the biasing force of the bias spring 26, thereby the shape memory alloy 245 being expanded. As a result, the relay member 305 slides toward the positive side of the X-axis direction and the rotational shaft 22 rotates in the counter rotation direction. The wiper 16 revolves in the counter rotation direction along with the rotation of the rotational shaft 22.

Upon power supply to the power supply terminals 285a and 285c being started, the section B2 of the shape memory alloy 245 performs self-heating due to the current supply to the alloy. The heat shrinkage occurs in the section B2 of the shape memory alloy 245, which causes the rotational shaft 22 to rotate in the positive rotation direction and the wiper 16 to revolve in the positive rotation direction.

When the power supply to the power supply terminals 285a and 285c is stopped, the section B2 of the shape memory alloy 245 is naturally cooled. When the temperature of the shape memory alloy 245 becomes lower than the transformation temperature, lattice deformation is produced by the biasing force of the bias spring 26, thereby the shape memory alloy 245 being expanded. As a result, the rotational shaft 22 rotates in the counter rotation direction and the wiper 16 revolves in the counter rotation direction.

Accordingly, when all the sections of the shape memory alloy 245 shrink, the wiper 16 revolves up to the maximum angle. When only the section A2 or B2 of the shape memory alloy 245 shrinks, the wiper 16 revolves to an angle smaller than the maximum angle. In other words, the revolving angle of the wiper 16 is changed in stages by switching the modes of power supply to the power supply terminals 285a through 285c.

Also in the present embodiment, by forming the shape memory alloy 245 in a linear shape, the power consumption for current supply can be suppressed and the response characteristics of the shape memory alloy 245 with respect to the current supply can be improved. Further, by separately supplying power to three or more mutually different positions of the shape memory alloy 245, the revolving angle of the wiper 16 can be appropriately changed. Moreover, because only a single shape memory alloy 245 is required to be arranged, the raindrop removing device 10 can be assembled with ease. Note that the revolving angle of the wiper 16 can be adjusted by changing a ratio between the length of the section A2 and the length of the section B2.

### Sixth Embodiment

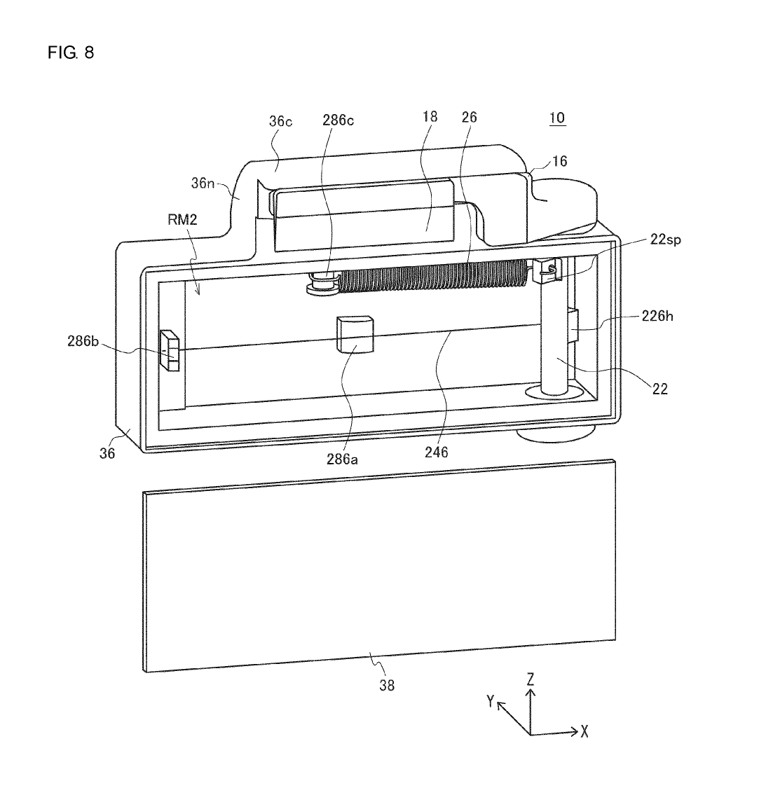

As shown in FIG. 8, in a raindrop removing device 10 of a sixth embodiment, when compared to the raindrop removing device 10 shown in FIG. 7, a power supply terminal 286a is employed in place of the power supply terminal 285a, and the relay member 305, the guides 305g, the relay terminals 325a and 325b, and the lead wire 345 are omitted.

It is noted that an SMA holding member 226h is the same as the SMA holding member 225h, power supply terminals 286b and 286c are the same as the power supply terminals 285b and 285c, respectively, and a shape memory alloy 246 is the same as the shape memory alloy 245. The materials of the SMA holding member 226h and the rotational shaft 22 are a metal such as aluminum or the like (a conductor in which plating or the like is performed on a surface of a resin such as PPS or the like may also be used). The bias spring 26 is formed of a spring member such as stainless steel or the like.

Accordingly, hereinafter, different points from the raindrop removing device 10 shown in FIG. 7 will be mainly described and redundant description on the same constituent elements will be omitted as much as possible.

The power supply terminal 286a is provided at a substantially central position of the bottom surface of the storage room RM2. To be more specific, the power supply terminal 286a is arranged at the same height position as that of the power supply terminal 286b, and is extended to the Y-axis positive outer side surface of the housing 36.

Hereinafter, of the sections included in the shape memory alloy 246 from one end (a connecting end with the power supply terminal 286b) to the other end (a connecting end with the SMA holding member 226h) thereof, a section from the one end to a position in contact with the power supply terminal 286a is defined as a “section A3”, and a section from the position in contact with the power supply terminal 286a to the other end is defined as a “section B3”.

In the present embodiment, the power supply terminals 286a through 286c can be considered a power supply system according to the exemplary aspect. Because the shape memory alloy 246 is connected to the power supply system in the manner described above, power is separately supplied to three or more mutually different positions of the shape memory alloy 246.

An external force in the counter rotation direction is applied to the rotational shaft 22 by the bias spring 26. As such, in a state where power is not being supplied to any of the power supply terminals 286a through 286c, the shape memory alloy 246 experiences lattice deformation at a temperature equal to or lower than the transformation temperature so as to be expanded. As a result, the wiper 16 revolves in the counter rotation direction and stops at a position where the wiper 16 makes contact with the nose 14n.

Upon power supply to the power supply terminals 286a and 286b being started, the section A3 of the shape memory alloy 246 performs self-heating due to the current supply to the alloy. The heat shrinkage occurs in the section A3 of the shape memory alloy 246. The design causes the rotational shaft 22 to revolve in the positive rotation direction, thereby the wiper 16 being revolved in the positive rotation direction.

When the power supply to the power supply terminals 286a and 286b is stopped, the section A3 of the shape memory alloy 246 is naturally cooled. When the temperature of the shape memory alloy 246 becomes lower than the transformation temperature in the section A3, lattice deformation is produced by the biasing force of the bias spring 26, thereby the shape memory alloy 246 being expanded. As a result, the rotational shaft 22 revolves in the counter rotation direction, thereby the wiper 16 being revolved in the counter rotation direction.

Upon power supply to the power supply terminals 286a and 286c being started, the section B3 of the shape memory alloy 246 performs self-heating due to the current supply to the alloy. The heat shrinkage occurs in the section B3 of the shape memory alloy 246. As a result, the rotational shaft 22 revolves in the positive rotation direction, thereby the wiper 16 being revolved in the positive rotation direction.

When the power supply to the power supply terminals 286a and 286c is stopped, the section B3 of the shape memory alloy 246 is naturally cooled. When the temperature of the shape memory alloy 246 becomes lower than the transformation temperature, lattice deformation is produced by the biasing force of the bias spring 26, thereby the shape memory alloy 246 being expanded. As a result, the rotational shaft 22 revolves in the counter rotation direction, thereby the wiper 16 being revolved in the counter rotation direction.

Accordingly, when all the sections of the shape memory alloy 246 shrink, the wiper 16 revolves up to the maximum angle. When only the section A3 or B3 of the shape memory alloy 246 shrinks, the wiper 16 revolves to an angle smaller than the maximum angle. In other words, the revolving angle of the wiper 16 is changed in stages by switching the modes of power supply to the power supply terminals 286a through 286c.

Also in the present embodiment, by forming the shape memory alloy 246 in a linear shape, the power consumption for current supply can be suppressed, and the response characteristics of the shape memory alloy 246 with respect to the current supply can be improved. Further, by separately supplying power to three or more mutually different positions of the shape memory alloy 246, the revolving angle of the wiper 16 can be appropriately changed. Moreover, because the relay member 305, the guides 305g, the relay terminals 325a and 325b, and the lead wire 345, which are shown in FIG. 7, are omitted, the raindrop removing device 10 can be assembled more easily. Note that the revolving angle of the wiper 16 can be adjusted by changing a ratio between the length of the section A3 and the length of the section B3.

### Seventh Embodiment

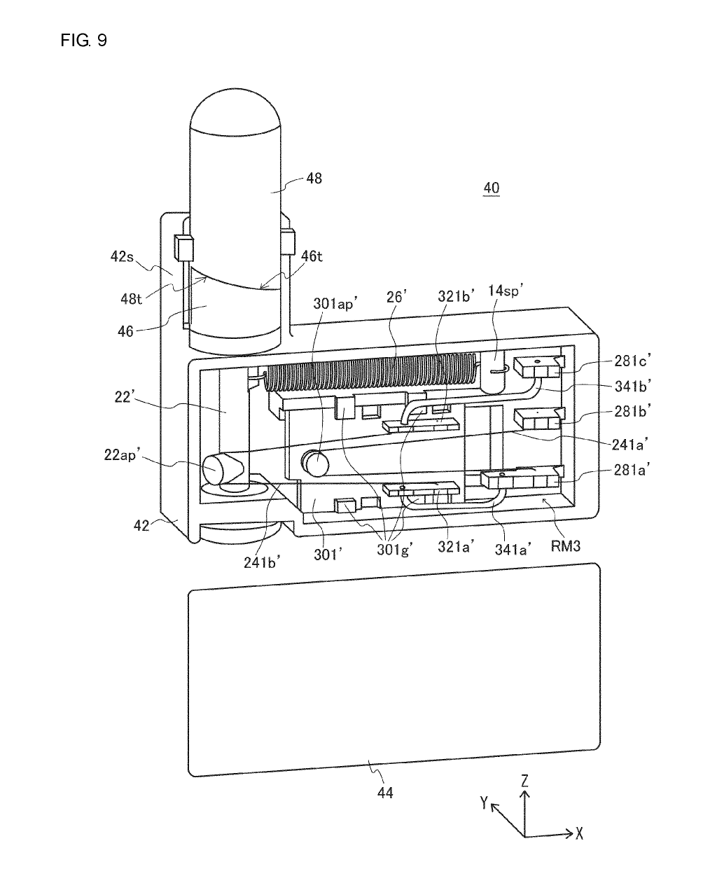

As shown in FIG. 9, a head driving device 40 of a seventh embodiment, when compared to the raindrop removing device 10 shown in FIG. 2, employs a housing 42 having the storage room RM2 in place of the housing 14 having the storage room RM1, a control head 46 and an action head 48 in place of the wiper 16, a rotation stopper 42s in place of the nose 14n, and a cover 44 in place of the cover 20.

A plurality of members provided in the storage room RM2 are the same as the plurality of members provided in the storage room RM1 of the raindrop removing device 10 shown in FIG. 2 except that the arrangement of the members is reversed in the X-axis direction. As such, redundant description will be omitted by putting a dash on the reference sign of each of the members.

One end of a rotational shaft 22′ passes through the Z-axis positive side wall of the housing 42 so as to protrude to the outside. The control head 46 and the action head 48 formed in a cylinder shape are mounted to the one end thereof. Specifically, the control head 46 and the action head 48 are aligned in that order from the negative side toward the positive side of the Z-axis direction. Further, an end surface 46t of the control head 46 on the positive side of the Z-axis direction is a tapered surface, and an end surface 48t of the action head 48 on the negative side of the Z-axis direction is also a tapered surface that makes contact with the end surface 46t of the control head 46. The control head 46 is fixedly mounted on the rotational shaft 22′, while the action head 48 is supported by the rotation stopper 42s in a mode in which the action head 48 can slide relative to the control head 46.

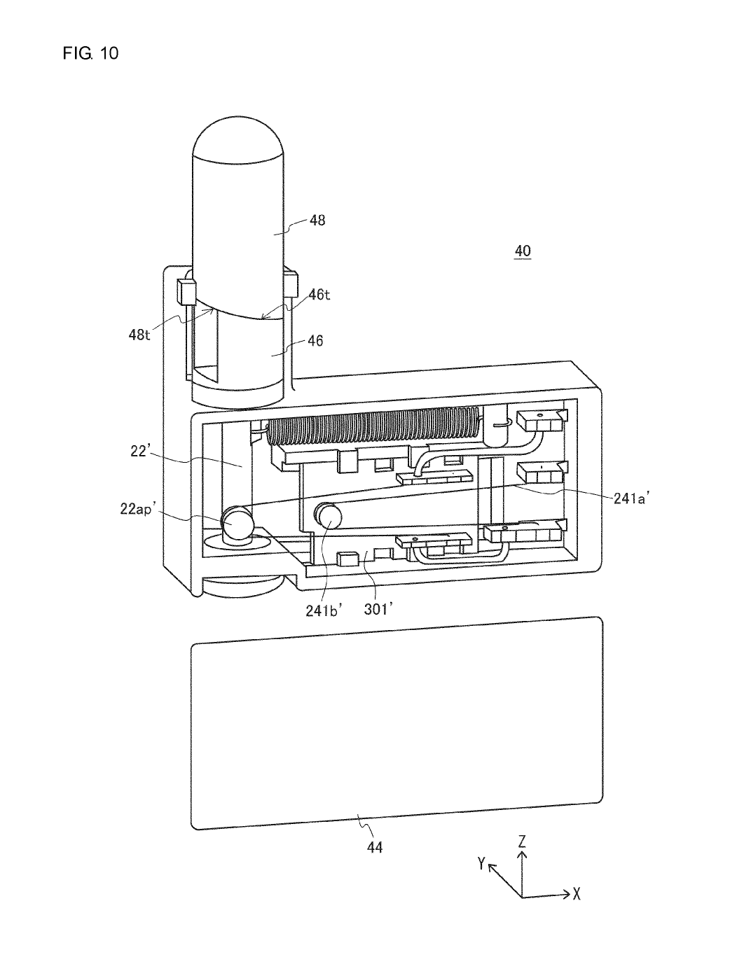

Accordingly, the action head 48 moves toward the positive side of the Z-axis direction when the rotational shaft 22′ rotates in the clockwise direction when viewed from the negative side of the Z-axis direction, and moves toward the negative side of the Z-axis direction when the rotational shaft 22′ rotates in the counterclockwise direction when viewed from the negative side of the Z-axis direction (see FIG. 10). In this manner, rotation motion of the rotational shaft 22′ is converted to linear motion in a direction orthogonal to the rotational shaft 22′.

### REFERENCE SIGNS LIST

10 RAINDROP REMOVING DEVICE (DRIVING DEVICE)
14, 36, 42 HOUSING
16 WIPER (TARGET MEMBER)
22, 22′ ROTATIONAL SHAFT (REVOLVING MEMBER)
241a-243a, 241a′ SHAPE MEMORY ALLOY (PARTIAL SHAPE MEMORY ALLOY)
241b-243b, 241b′ SHAPE MEMORY ALLOY (PARTIAL SHAPE MEMORY ALLOY)
244-246 SHAPE MEMORY ALLOY
26, 26′ BIAS SPRING (ELASTIC BODY)
281a-281c, 282a-282c, 283a-283c, 284a-284c, 285a-285c, 286a-286c, 281a′-281c′ POWER SUPPLY TERMINAL (PART OF POWER SUPPLY SYSTEM)
301-305, 301′ SUPPORT MEMBER
321a-321b, 322a-322c, 323a-323b, 324, 325a-325b, 321a′-321b′ RELAY TERMINAL (ANOTHER PART OF POWER SUPPLY SYSTEM, SPECIFIC POWER SUPPLY TERMINAL)
341a-341b, 342-345, 341a′-341b′ LEAD WIRE (ANOTHER PART OF POWER SUPPLY SYSTEM)
40 HEAD DRIVING DEVICE (DRIVING DEVICE)
46 CONTROL HEAD
46t END SURFACE (FIRST END SURFACE)
48 ACTION HEAD (TARGET MEMBER)
48t END SURFACE (SECOND END SURFACE)

1. A driving device comprising:
a revolving member supported by a housing and configured to rotate in a first rotational direction and a second rotational direction opposite the first rotational direction about an axis;
at least one shape memory alloy having a wire-like shape that is coupled to the revolving member and that shrinks when power is supplied thereto, such that an external force is applied to the revolving member acting in the first rotational direction;
an elastic body coupled to the revolving member and configured to apply an external force to the revolving member acting in the second rotational direction;
a target member coupled to the revolving member that is displaced when the revolving member rotates in the first and second rotational directions; and
a power supply system including at least three power supply terminals disposed in the housing and electrically coupled to three separate positions of the at least one shape memory alloy, such that a potential difference between the power supply terminals adjacent to each other is applied to the at least one shape memory alloy.

2. The driving device according to claim 1, further comprising a support member that is provided in the housing and configured to move towards and away from the revolving member.

3. The driving device according to claim 2, wherein the three separate positions include connections for supplying a current to respective portions of the at least one shape memory alloy.

4. The driving device according to claim 2, wherein the at least one shape memory alloy is supported by the support member and extends in a zigzag pattern.

5. The driving device according to claim 2, wherein the at least one shape memory alloy comprises a pair of shape member alloys.

6. The driving device according to claim 5, wherein the pair of shape memory alloys at least partially overlap with each other when viewed in a direction parallel to a direction of the axis of the revolving member.

7. The driving device according to any one of claim 1, wherein the target member includes a wiper configured to revolve so as to remove raindrops.

8. The driving device according to claim 1,
wherein the revolving member includes a tapered first end surface at one end in a direction of the axis of the revolving member, and
wherein the target member includes a tapered second end surface that contacts with the first end surface when the revolving member rotate in the second rotational direction.

9. The driving device according to claim 2, wherein the at least one shape memory alloy comprises first and second shape memory alloys with the first shape memory alloy electrically coupled to first and second of the at least three power supply terminals and the second shape memory alloy electrically coupled to the second and third of the at least three power supply terminals.

10. The driving device according to claim 9, wherein the support member comprises a post and the first shape memory alloy is coupled to the first and second power supply terminals and wound around the post, such that the first shape memory alloy causes the support member to move towards the first and second supply terminals when the first shape memory alloy shrinks when power is applied thereto.

11. The driving device according to claim 10, wherein the revolving member comprises a post and the second shape memory alloy is electrically coupled to the second and third power supply terminals and wound around the post of the revolving member, such that the second shape memory alloy causes the revolving member to rotate in the first rotational direction when the second shape memory alloy shrinks when power is applied thereto.

12. The driving device according to claim 11, wherein the support member comprises a pair of relay terminals disposed thereon with ends of the second shape memory alloy physically coupled thereto, respectively.

13. The driving device according to claim 12, wherein the pair of relay terminals are coupled to the first and third power supply terminals, respectively, by a pair of level wires.

14. The driving device according to claim 1, wherein the at least one shape memory alloy comprises first and second shape memory alloys with the first shape memory alloy electrically coupled to first and second of the at least three power supply terminals and the second shape memory alloy electrically coupled to the second and third of the at least three power supply terminals.

15. The driving device according to claim 1, further comprising a plurality of relay terminals with a first relay terminal coupling the first shape memory alloy to the revolving member and a second relay terminal coupling the second shape memory alloy to at least one of the power supply terminals.

16. The driving device according to claim 15, wherein the first and second relay terminals are coupled to each other to form a relay member and revolve about a pin.

17. The driving device according to claim 1, further comprising a support member that is provided in the housing and configured to move towards and away from the revolving member,
wherein the support member comprises a pair of posts extending from a surface thereof and the at least one shape memory alloy is wound around the pair of posts.

18. The driving device according to claim 17, wherein the at least one shape memory alloys extends in a zig zag pattern in a direction orthogonal to the axis of the revolving member.

19. The driving device according to claim 1,
wherein a first power supply of the power supply system is disposed in the housing on a side opposite the revolving member,
wherein a second power supply of the power supply system is disposed in a middle of the housing, and
wherein the at least one shape memory alloy is couple between the first power supply and the revolving member and has a portion in contact with the second power supply.

20. The driving device according to claim 19, wherein a third power supply of the power supply system provides a support for the elastic body.
